(19) United States
(12) Patent Application Publication
(10) Pub. No.: US 2011/0250116 A1
(43) Pub. Date: Oct. 13, 2011

(54) Process for Producing Trichlorosilane and Tetrachlorosilane

(76) Inventors: Patrick James Harder, Midland, MI (US); Arthur James Tselepis, Midland, MI (US)

(21) Appl. No.: 13/127,987

(22) PCT Filed: Nov. 17, 2009
(86) PCT No.: PCT/US09/64721

§ 371 Date: May 6, 2011

Related U.S. Application Data
(60) Provisional application No. 61/119,391, filed on Dec. 3, 2008.

(51) Int. Cl. C01B 33/107

(52) U.S. Cl. 423/342

(57) ABSTRACT

A process for reducing waste and increasing yield of chlorosilane monomers is performed by cracking polychlorosiloxane and polychlorosilane by-products generated during production of trichlorosilane useful for the manufacture of polycrystalline silicon.

### CROSS REFERENCE TO RELATED APPLICATIONS

This application claims the benefit of U.S. Provisional Patent Application No. 61/119,391 filed on 3 Dec. 2008. U.S. Provisional Patent Application No. 61/119,391 is hereby incorporated by reference.

### STATEMENT REGARDING FEDERALLY FUNDED RESEARCH

None.

### BACKGROUND

1. Technical Field

This invention relates to a method for cracking high boiling polymers to improve yield and minimize waste in a process for making trichlorosilane (HSiCl₃). The polymers include tetrachlorodisiloxane (H₂Si₂OCl₄), pentachlorodisiloxane (HSi₂OCl₅), hexachlorodisiloxane (Si₂OCl₆), and hexachlorodisilane (Si₂Cl₆). The cracking process produces additional HSiCl₃ and/or tetrachlorosilane (SiCl₄) useful in process for producing polycrystalline silicon.

2. Problem to be Solved

SiCl₄ is a by-product produced when silicon is deposited on a substrate in a chemical deposition (CVD) reactor that uses a feed gas stream comprising HSiCl₃ and hydrogen (H₂). It is desirable to convert the SiCl₄ back to HSiCl₃ to be used in the feed gas stream. One process for converting SiCl₄ back to HSiCl₃ comprises feeding H₂ and SiCl₄ to a fluidized bed reactor (FBR) having silicon particles therein. The FBR operates at high pressure and temperature where the following reaction occurs.

3SiCl₄+2H₂+Si [symbol] 4HSiCl₃

Partial conversion of the H₂ and SiCl₄ to HSiCl₃ is achieved due to equilibrium limitations. H₂ is separated from the chlorosilanes and is recycled back to the feed. Likewise, unconverted SiCl₄ is distilled from the product HSiCl₃ and is recycled. Product HSiCl₃ may be further distilled to remove impurities.

Residue is generated in the FBR along with the intended product HSiCl₃. Residue, which is heavier than SiCl₄, accumulates in the bottoms from the distillation apparatus. Residue typically comprises polychlorosilanes and/or polychlorosiloxanes exemplified by partially hydrogenated species, including tetrachlorodisiloxane (H₂Si₂OCl₄) and pentachlorodisiloxane (HSi₂OCl₅); and other high boiling species, including hexachlorodisiloxane (Si₂OCl₆) and hexachlorodisilane (Si₂Cl₆). Residue further comprises silicon particulates, which must periodically be removed. The residue is periodically pumped out and disposed of.

One approach for converting polychlorosilanes and polychlorosiloxanes has been proposed in which these species are fed back to the FBR for making HSiCl₃. However, it is thought that this process may not be industrially desirable because of limitations presented by reaction kinetics at typical reactor temperatures unless considerable recycle passes are undertaken. This process is also complicated by the interference of the recycle stream with hydrodynamics in the reactor and the intended HSiCl₃ generating reaction itself.

### SUMMARY

A process for cracking polychlorosilanes and/or polychlorosiloxanes comprises: recycling a clean mixture comprising polychlorosilanes and/or polychlorosiloxanes to a distillation apparatus; thereby producing trichlorosilane, tetrachlorosilane, or a combination thereof.

### BRIEF DESCRIPTION OF THE DRAWINGS

FIG. 1 is a process flow diagram showing a process of this invention.

Reference Numerals

| | | | |
|---|---|---|---|
| 101 | SiCl₄ feed line | 111 | sump |
| 102 | H₂ feed line | 113 | distillation feed line |
| 103 | fluidized bed reactor | 115 | overheads mixture removal line |
| 105 | silicon particle feed line | 117 | residue removal line |
| 107 | crude product line | 119 | solids removing apparatus |
| 108 | dust removing apparatus | 121 | solids removal line |
| 109 | silicon particle recycle line | 123 | clean mixture line |
| 110 | distillation column | | |

### DETAILED DESCRIPTION

A process for cracking polychlorosilanes and/or polychlorosiloxanes is described herein. The process may comprise:
a. producing a mixture comprising a polychlorosilane and/or a polychlorosiloxane;
optionally b. removing solids from the mixture to form a clean mixture;
c. recycling the clean mixture to a distillation apparatus; thereby producing trichlorosilane, tetrachlorosilane, or a combination thereof.

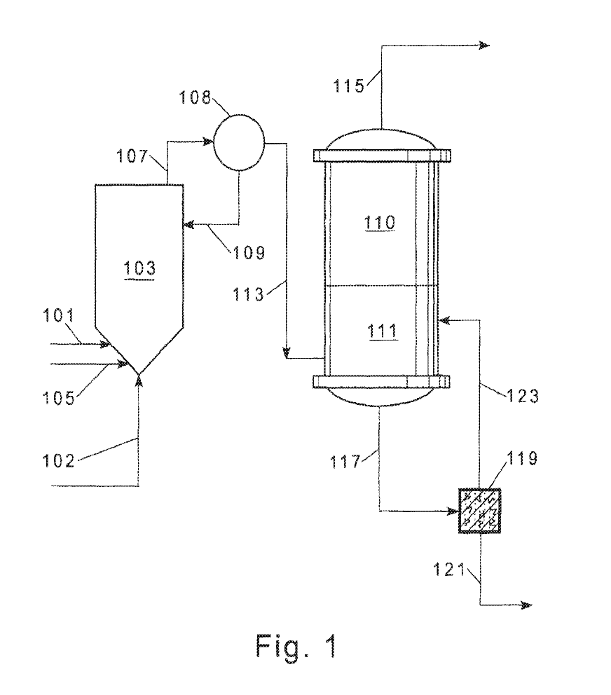

FIG. 1 shows a process flow diagram of an exemplary process for preparing HSiCl₃. SiCl₄ is fed through line 101, and H₂ is fed through line 102, into a FBR 103. Silicon particles are fed into the FBR through line 105 and form a fluidized bed in the FBR 103. A crude product stream comprising HSiCl₃, SiCl₄, silicon solids, and H₂ is drawn off the top of the FBR 103 through line 107. The silicon solids may be removed with a dust removing apparatus 108 such as a cyclone, and returned to the FBR 103 through line 109. The resulting effluent mixture is fed to the sump 111 of a distillation column 110 through line 113.

The sump 111 of the distillation column 110 may contain a catalyst that facilitates cracking of the polychlorosiloxane and polychlorosilane species. Some catalysts may inherently form in the sump 111 of the distillation column 110 resulting from impurities such as tin, titanium, or aluminum. Examples such catalysts include, but are not limited to, titanium dichloride, titanium trichloride, titanium tetrachloride, tin tetrachloride, tin dichloride, iron chloride, AlCl₃, and a combination thereof. The amount of such catalyst depends on various factors including how frequently the residue is removed from the distillation apparatus 110 and the level of the catalyst present in the effluent mixture from the FBR 103. Alternatively, a catalyst can be added to the sump 111. Platinum group metal catalysts such as platinum, palladium, osmium, iridium, or heterogeneous compounds thereof can be used. The platinum group metal catalysts may optionally be supported on substrates such as carbon or alumina. The amount of catalyst may vary depending on the type of catalyst and the factors described above, however, the amount may range from 0 to 20%, alternatively 0 to 10% of the residue. One skilled in the art would recognize that different catalysts have different catalytic activities and would be able to select an appropriate catalyst and amount thereof based on the process conditions in the distillation apparatus 110 and the sump 111.

A mixture including SiCl₄, HSiCl₃, and H₂ is removed from the top of the distillation column 110 through line 115. The SiCl₄ and H₂ may be recovered and fed back to the FBR 103, as described above. The HSiCl₃ may optionally be used as a feed gas for a CVD reactor (not shown) for the production of polycrystalline silicon.

Residue is generated in the FBR 103 along with the intended product HSiCl₃. Residue, which is heavier than SiCl₄, accumulates in the sump 111. The residue is periodically removed through line 117. Residue typically comprises a polychlorosilane and/or a polychlorosiloxane. Such polychlorosilanes and polychlorosiloxanes are exemplified by partially hydrogenated species, including tetrachlorodisiloxane (H₂Si₂OCl₄) and pentachlorodisiloxane (HSi₂OCl₅); and other high boiling species, including hexachlorodisiloxane (Si₂OCl₆) and hexachlorodisilane (Si₂Cl₆). The exact amount of each species of polychlorosilane and polychlorosiloxane in the residue may vary depending on the process chemistry and conditions that produce the residue. However, residue may contain 0 to 15% H₂Si₂OCl₄, 5% to 35% HSi₂OCl₅, 15% to 25% Si₂OCl₆, and 35% to 75% Si₂Cl₆, based on the combined weights of the polychlorosilanes and polychlorosiloxanes in the residue. Residue may further comprise solids, which are insoluble in the species described above. For example, the solids may be polychlorosiloxanes having 4 or more silicon atoms and higher order polychlorosilanes. The solids may further comprise silicon particulates, which may optionally be recovered as described below and optionally recycled to the FBR 103.

The residue may be fed to a solids removing apparatus 119. The solids may be removed through line 121. The clean mixture (i.e., the mixture comprising tetrachlorodisiloxane, pentachlorodisiloxane, hexachlorodisiloxane, and hexachlorodisilane with the solids removed) may be sent through line 123 back to the sump 111.

FIG. 1 is intended to illustrate the invention to one of ordinary skill in the art and should not be interpreted to limit the scope of the invention set forth in the claims. Modifications may be made to FIG. 1 by one of ordinary skill in the art and still embody the invention. For example, one skilled in the art would recognize that cyclone 108 is optional and that one or more of the feeds in lines 101, 102, and 105 may optionally be combined before being fed into the FBR 103. One skilled in the art would recognize that the distillation column 110 can have a different configuration than that shown in FIG. 1, e.g., a separate reboiler into which gas from line 113 is fed may be used instead of the sump 111. The residue would then accumulate in the reboiler. Furthermore, an alternative process for producing HSiCl₃ may be used, for example, an alternative FBR 103 that produces HSiCl₃ from HCl and particulate silicon.

Cracking reactions of the polychlorosilane and/or polychlorosiloxane species in the clean mixture can form monomeric chlorosilane species (HSiCl₃ and SiCl₄) and higher order silane and siloxane polymers with each successive reaction of the species in the clean mixture. The siloxane polymers become large enough to form solids at approximately 4 units long. Under the conditions in the distillation apparatus, polychlorosilanes undergo cracking reactions, similarly. The partially hydrogenated species described above exhibit equilibria with HSiCl₃, and the other (not hydrogenated) species described above, exhibit equilibria with SiCl₄ according to the following reactions:

HₙSi₂OCl₆₋ₙ [symbol] Hₙ₋₁Si₃O₂Cl₈₋ₙ+HSiCl₃,

where subscript n represents the number of hydrogen atoms, e.g., 1 or 2,

Si₂OCl₆ [symbol] Si₃O₂Cl₈+SiCl₄.

When the polychlorosiloxanes reach a degree of polymerization of 4 or greater, a solid may form and the reaction may become irreversible, as illustrated below:

HₙSi₃O₂Cl₈₋ₙ→Hₙ₋₁Si₄O₃Cl₁₀₋ₙ(solid)+HSiCl₃,

and

Si₃O₂Cl₈→Si₄O₃Cl₁₀(solid)+SiCl₄.

Based on the kinetic data, the reactions above all occur at different rates in the sump 111 to permit the above equilibria to be reached within the residence time for the species in the sump 111 when the clean mixture is recycled. The sump 111 may operate at 130° C. to 280° C., alternatively to 180° C. to 240° C., and alternatively 200° C. to 220° C., for a residence time ranging from 10 days to 1 hour at a pressure ranging from 25 bar to 40 bar. One skilled in the art would recognize that the residence time selected depends on various factors including the temperature and the presence or absence of a catalyst. The pressure may be selected based on practical limitations. Increasing pressure will increase the boiling temperatures in the distillation apparatus. The range of pressures enable the reaction to occur at the appropriate temperatures, and therefore at sufficient rate.

### INDUSTRIAL APPLICABILITY

The process described herein reduces waste and improves yield of chlorosilane monomers (HSiCl₃ and SiCl₄) useful for the production of polycrystalline silicon. Polychlorosilanes and polychlorosiloxanes that otherwise would have been disposed of as waste are cracked to form useful HSiCl₃ and SiCl₄.

1. A process comprises: step a) recycling a clean mixture comprising a polychlorosilane and/or a polychlorosiloxane to a distillation apparatus and cracking the polychlorosilane and/or polychlorosiloxane; thereby producing trichlorosilane, tetrachlorosilane, or a combination thereof.

2. The process of claim 1, where the clean mixture is obtained by a method comprising:
b) producing a mixture comprising a polychlorosilane and/or a polychlorosiloxane; and
optionally c) removing solids from the mixture to form the clean mixture.

3. The process of claim 1, where the clean mixture is recycled to a sump of the distillation apparatus.

4. The process of claim 1, where the clean mixture is recycled to a reboiler of a distillation apparatus.

5. The process of claim 2, where step c) is present, and the solids are recycled to a fluidized bed reactor for making trichlorosilane.

6. The process of claim 1, where the polychlorosilane is selected from the group consisting of hexachlorodisilane, pentachlorodisilane, tetrachlorodisilane, and a combination thereof.

7. The process of claim 1, where the polychlorosiloxane is selected from the group consisting of tetrachlorodisiloxane, pentachlorodisiloxane, hexachlorodisiloxane, and a combination thereof.

8. The process of claim 1, where the distillation apparatus operates at a temperature ranging from 130° C. to 280° C. when the residence time ranges from 10 days to 1 hour at a pressure ranging from 25 bar to 40 bar.

9. The process of claim 2, where the process further comprises: d) feeding an effluent from a fluidized bed reactor producing trichlorosilane to the distillation apparatus before step b).

10. The process of claim 9, where the effluent is a crude product stream comprising tetrachlorosilane, trichlorosilane, silicon solids, and hydrogen.

11. The process of claim 9, where the process further comprises: e) removing silicon solids from the effluent before step d).

12. The process of claim 1, where a catalyst is in the reboiler.

13. The process of claim 12, where the catalyst is selected from the group consisting of a chloride of titanium, tin, aluminum, or a combination thereof.

14. The process of claim 12, where the catalyst comprises a platinum group metal.
